(19) United States
(12) Patent Application Publication
(10) Pub. No.: US 2004/0069422 A1
(43) Pub. Date: Apr. 15, 2004

(54) Enclosure, specifically sectional door

(76) Inventor: Michael Hormann, Oerlinghausen (DE)

Correspondence Address: ROCCO S. BARRESE ESQ., DILWORTH & BARRESE, LLP, 333 Earle Ovington Blvd., Uniondale, NY, 11553, US

(21) Appl. No.: 10/606,386

(22) Filed: Jun. 26, 2003

(30) Foreign Application Priority Data
Jun. 27, 2002 (DE) 202 09 960.1

(51) Int. Cl. E06B 3/48

(52) U.S. Cl. 160/229.1

(57) ABSTRACT

The invention relates to an enclosure that consists of segments that can be rotated toward one another around joints, with the adjacent edges of the segments being formed in a concave or convex manner, in order to form a narrow gap between them during rotation around an articulating axis. The joints consist of two articulating arms, firmly attached to adjacent segments, that are attached to one another in such a way as to be rotatable toward one another around the articulating axis. According to the invention, one of the adjacent segments has a recess running parallel to the edge, in which the articulating axis is positioned at least partially.

The invention relates to an enclosure consisting of segments that can be rotated toward one another around joints, specifically a sectional door, according to the characterizing clause of claim 1.

Doors of this kind are known for example from German registered utility model DE 88 00 958 U1. Therein it is already described that the individual segments have edges that are adjacent to one another when the enclosure is in the closed position, with one of the edges being curved in a convex manner and the articulating axis being positioned on the inside of it and at a distance from this edge, and with the other edge, which is shaped in a concave manner, reaching the convex edge, at least at its furthest extensions, in such a way that the gap between the two edges on the outer side of the enclosure does not exceed a maximum gap width when the segments are rotated. This ensures that fingers cannot be caught in the gap area since the gap is usually designed to be so narrow that effective protection against pinching is guaranteed. The convex edge of the first segment is curved in an approximately cylindrical manner, with the cylinder's axis lining up with the articulating axis positioned on the inside of this segment. In order to prevent access from the side, each hinge belonging to the articulating joint is furnished near the articulating axis with a specifically provided arc-shaped cover wing that closes off to the outside the crotch space that arises along the articulating axis in the axial direction of the articulating axis when the segments are rotated towards one another. These arc-shaped cover wings project outwards on the inner surface of the enclosure, jutting outward in a nose-shaped manner with their corner edge, so that, when the enclosure is closed, protruding barbs are formed that entail a risk of injury that should not be underestimated.

The object of the invention is to further develop an enclosure with an articulating connection according to the characterizing clause of claim 1 in such a way that risk of injury from such protruding parts forming corresponding corners is securely prevented.

The object is achieved according to the invention by an enclosure with the characteristics of claim 1. According to it, one of the adjacent segments has a recess running parallel to the edge, in which the articulating axis is positioned at least partially. [By] this receding of the articulating axis below the segment surface forming the inner wall, protruding parts of the joints can be avoided.

Preferred embodiments of the invention result from the subordinate claims following the main claim. According to them, the recess for accommodating the articulating axis can be designed preferably in the form of a groove.

The articulating arms of the joints connecting the segments can be comprised of L-profiles. These have a particularly good stability. Tab-like extensions can be molded onto the L-profiles in order to accommodate the articulating axis.

According to an advantageous embodiment of the invention, one surface of the L-profiles is attached flat onto the segment, while the other surface of the L-profile projects perpendicularly to the segment. It is true that, in this case too, a piece protruding perpendicular to the segment is formed, but this piece is extended lengthwise and preferably rounded off on the edges, so that catching or risk of injury is ruled out. Meanwhile the end edges of the protruding surface of the L-profile are rounded off in such a way that between the concave edge of the adjacent segment and the end edge only a small gap remains during the rotation. In this way, this design variant also provides a protection against access from the side—however with different elements compared to the prior art that no longer entail a risk of injury.

An especially advantageous embodiment of the invention results from one surface of the L-profiles lying flat on and being attached to the respective segment, while the other surface of the L-profile runs perpendicular and parallel to the side edges of the segments. In this case the L-profile is, so-to-speak, laid on the outer corner area of the segment and attached to it. In this design variant, there are no protruding parts present that jut out over the inner surface of the segments.

Further details and advantages of the invention are shown in the attached drawings.

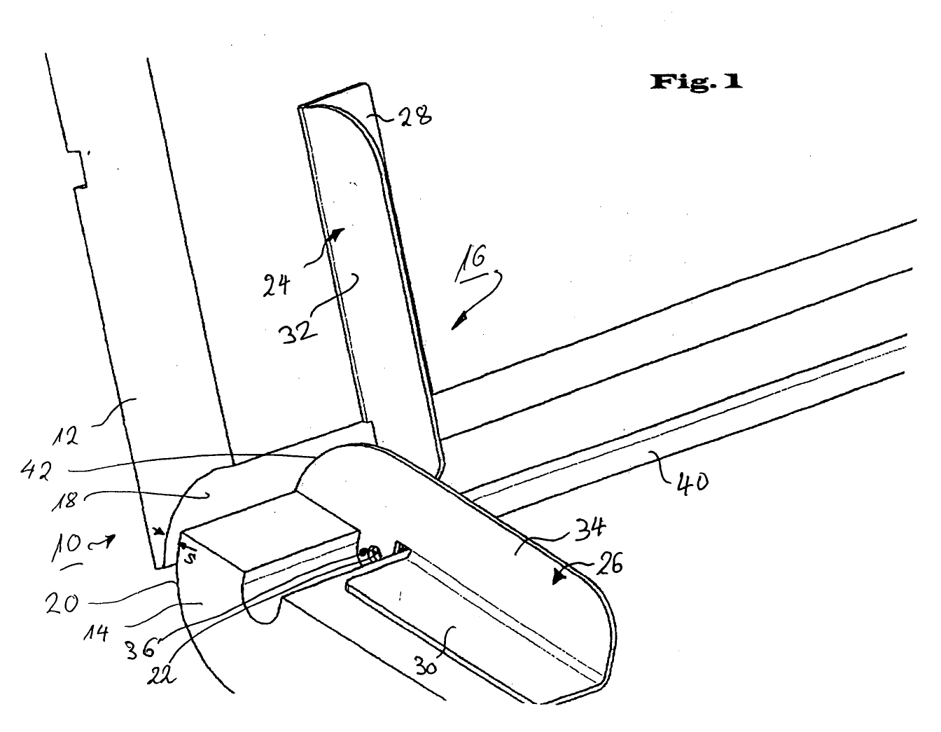

FIG. 1: shows a schematic view of a detail of a first embodiment of the enclosure according to the invention,

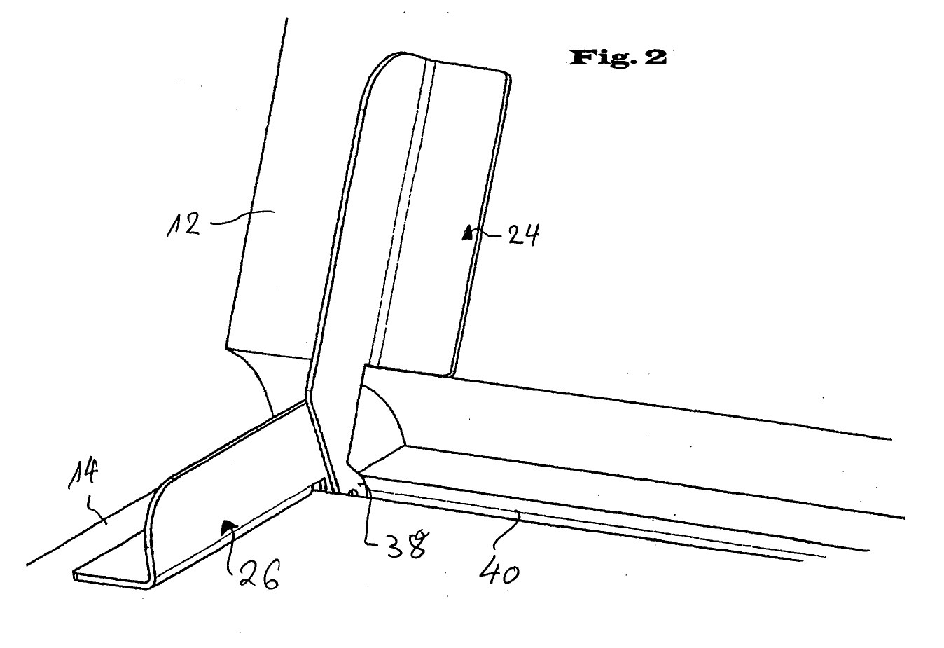

FIG. 2: shows a perspectival view of the object according to FIG. 1 from another direction,

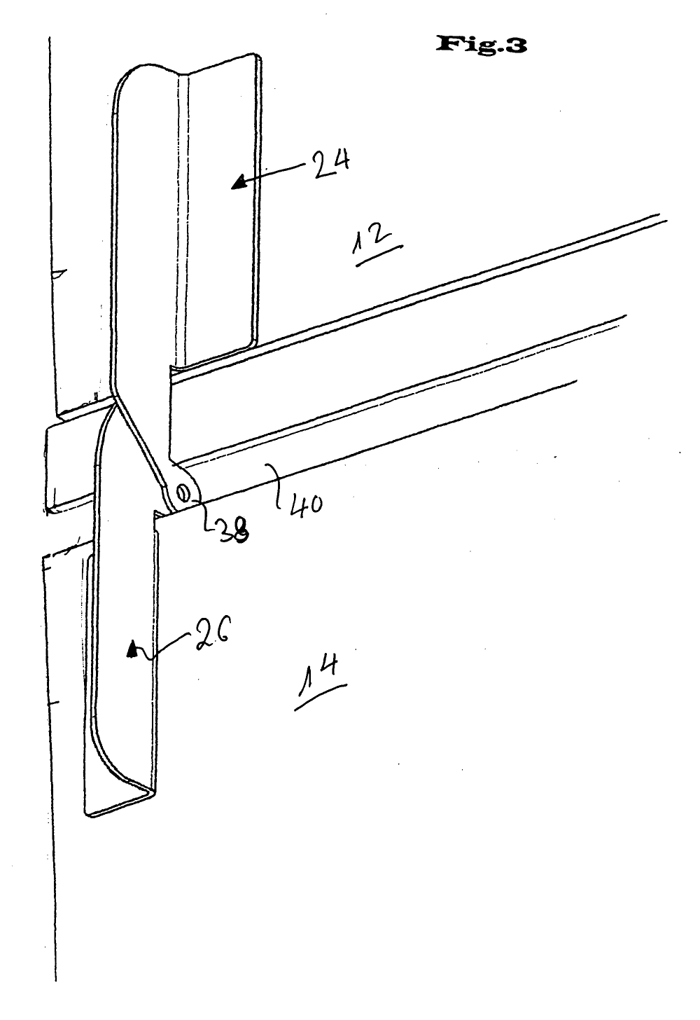

FIG. 3: shows a perspectival view of the object according to FIGS. 1 and 2, with the segments of the enclosure extended at 180°,

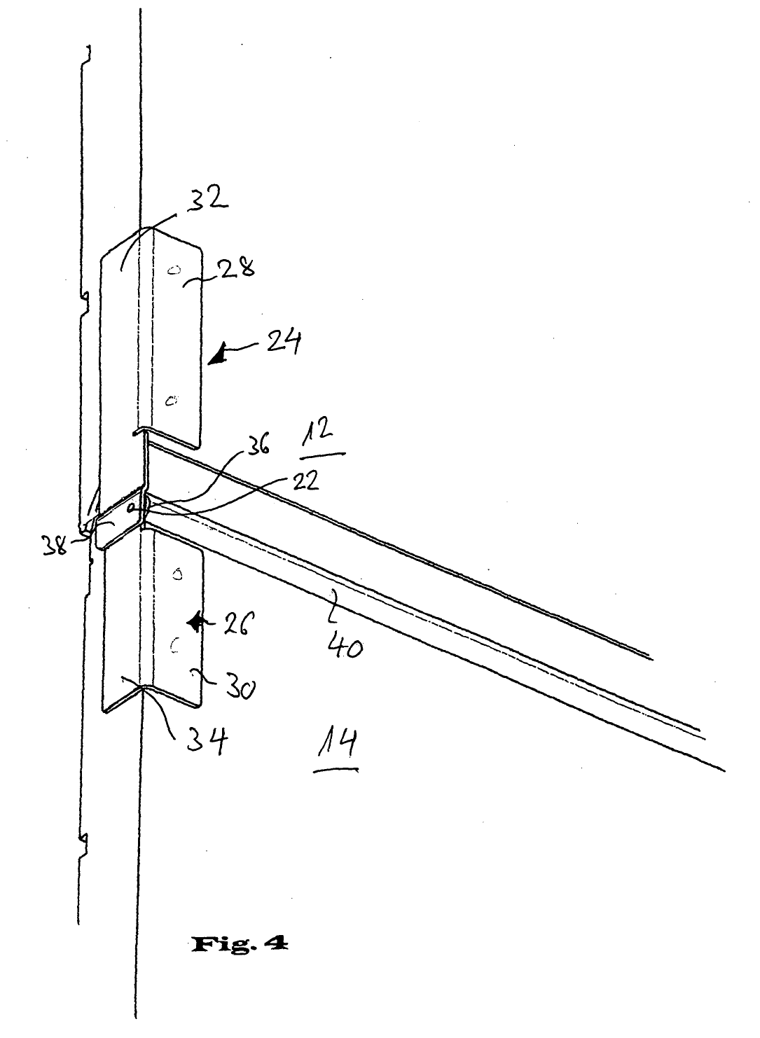

FIG. 4: shows a perspectival view of a detail of an enclosure with an articulating connection according to an alternative design variant of the present invention and

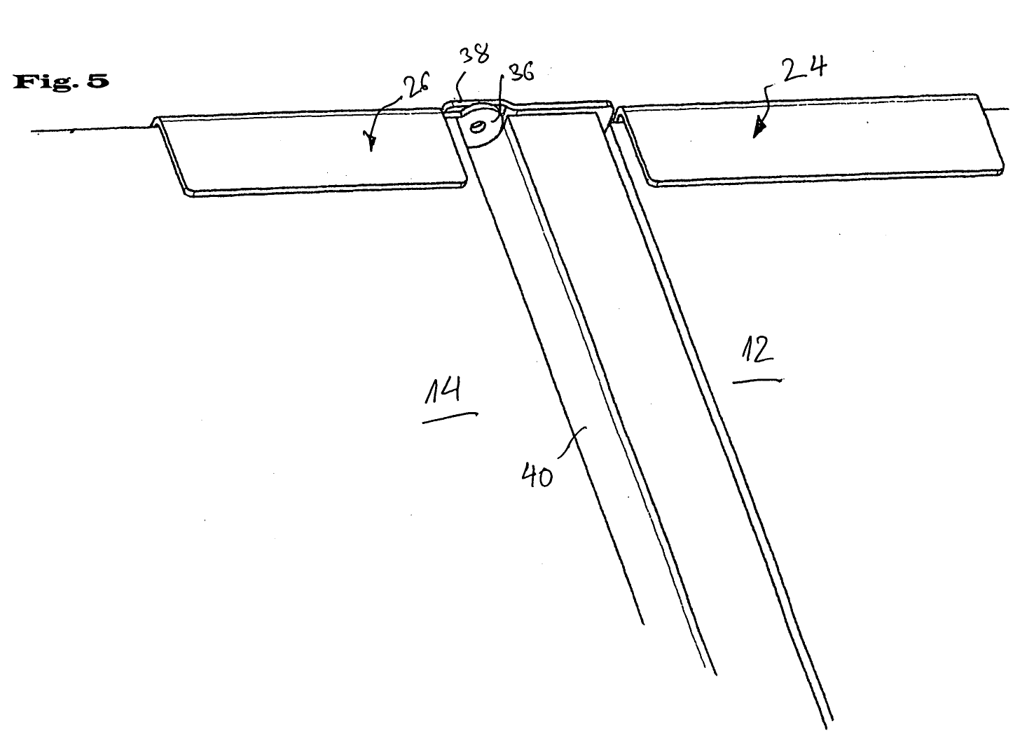

FIG. 5: shows the object according to FIG. 4 from another direction.

FIG. 1 shows part of two segments 12 and 14 of an enclosure, for example a garage door 10. These segments are attached to one another in a rotatable manner by means of joints 16, with one joint 16 being shown here in FIG. 1. Across the width of the garage door several of these joints 16 are positioned, depending on the width [of the door], in a manner not shown here. A lower edge 18 of segment 12 lies adjacent to an upper edge 20 of segment 14. Edges 18 and 20 are curved approximately cylindrically, and in the closed position they run concentrically around an articulating axis 22, with a gap s of only one millimeter to at most a few millimeters remaining between edges 18 and 20 during the rotation of segments 12 and 14 toward one another. As shown in FIG. 1, edge 18 is curved in a concave manner, and edge 20 is curved in a convex manner according to FIG. 1.

Joint 16 consists of two articulating arms 24 and 26. Articulating arms 24 and 26 are in the form of an L-profile along the majority of their length. One surface, namely surface 28 of articulating arm 24 and surface 30 of articulating arm 26, lie [sic] flat on the inner sides of segments 12 and 14 and are firmly attached to them, for example with screws (not shown in detail here). The perpendicularly projecting surfaces 32 of articulating arm 24 and 34 of articulating arm 26 extend lengthwise and have rounded-off end areas, so that no protrusions forming corners or sharp edges are formed on the inner side of the enclosure. Both articulating arm 26 and articulating arm 24 have tab-like extensions that contain drill-holes for accommodating the articulating axis not shown in detail here in the drawings. Tab-like extension 36 of articulating arm 26 (see FIG. 1) and tab-like extension 38 of articulating arm 24, when mounted, lie within a semi-cylindrical groove 40 that is recessed into segment 14 near convex edge 20. Thus the articulating axis (not shown here) lies within this groove. Articulating arms 24 and 26, and thus segments 12 and 14, can be rotated toward one another around articulating axis 22. In FIG. 3 the segments are aligned at 180° to one another. This corresponds to the closed position of the enclosure element, i.e. the garage door.

As can be seen particularly in FIGS. 1 and 2, edge 42 of perpendicular surface 34 of articulating arm 26 is rounded off in such a way that its radius essentially corresponds to the radius of concave edge 18 of segment 12. In this way, only a small gap—of constant width—is formed when segment 12 is rotated toward segment 14, so that here as well an effective protection against pinching is achieved.

FIGS. 4 and 5 show another embodiment of the present invention. Here those parts that correspond to the parts of the respective previously-described embodiment are labeled with the same numerals. In the present case, the L-profiles that form articulating arms 24 and 26 are attached to segments 12 and 14 at the edge areas of segments 12 and 14. Edge 28 of articulating arm 24 and edge 30 of articulating arm 26 are again attached to the inner surface of the sectional door, while perpendicularly protruding surfaces 32 of articulating arm 24 and 34 of articulating arm 30 do not stand out perpendicular to the inner surface of segments 12 and 14 in this design variant, but rather run perpendicular and parallel to the side edges of segments 12 and 14, partially covering them. Respective tab-like extensions 35 and 38 that form the corresponding accommodating holes for articulating axis 22, which is not presented here, likewise run sideways along the side edge of segments 12 and 14 and are positioned in such a way that articulating axis 22 lies here too in the vicinity of semi-cylindrical groove 40. Tab-like extension 38 of surface 32 of L-profile 24 extends across the entire width of surface 32, so that a protection against access from the side is formed here.

1. Enclosure consisting of segments that can be rotated toward one another around joints, specifically a sectional door, with the adjacent edges of the segments being formed essentially in a concave or convex manner, in order to form a narrow gap between them during rotation around an articulating axis, with the articulating axis being positioned essentially at the midpoint of the curve of the edges, and with each of the joints consisting of two articulating arms, firmly attached to adjacent segments, that are attached to one another in such a way as to be rotatable toward one another around the articulating axis,
characterized in that
one of the adjacent segments has a recess running parallel to the edge, in which the articulating axis is positioned at least partially.

2. Enclosure according to claim 1, characterized in that the recess for accommodating the articulating axis is in the form of a groove.

3. Enclosure according to claim 1 or 2, characterized in that the articulating arms consist of L-profiles.

4. Enclosure according to one of claims 1 to 3, characterized in that extensions are molded onto the L-profiles for accommodating the articulating axis.

5. Enclosure according to one of claims 1 to 4, characterized in that one surface of the L-profiles lies flat on the respective segment and is attached to it, while the other surface of the L-profile stands out perpendicularly from the segment.

6. Enclosure according to claim 5, characterized in that the end edge of the protruding surface of the L-profile is rounded off in such a way that between the concave edge of the adjacent segment and the end edge only a small gap remains during the rotation.

7. Enclosure according to claim 1, characterized in that one surface of the L-profiles lies flat on the respective segment and is attached to it, while the other surface of the L-profile runs perpendicular and parallel to the side edges of the segments and partially covers them.
